(19) United States
(12) Patent Application Publication
(10) Pub. No.: US 2012/0162567 A1
(43) Pub. Date: Jun. 28, 2012

(54) ELECTRONIC DEVICE

(75) Inventor: Tsuyoshi SHIMOMICHI, Fuchu-shi (JP)

(73) Assignee: KABUSHIKI KAISHA TOSHIBA, Tokyo (JP)

(21) Appl. No.: 13/295,387

(22) Filed: Nov. 14, 2011

(30) Foreign Application Priority Data
Dec. 27, 2010 (JP) 2010-291095

(51) Int. Cl. G02F 1/1333

(52) U.S. Cl. 349/58

(57) ABSTRACT

According to one embodiment, an electronic device is provided with a liquid crystal panel, a light guide body which is opposed to the liquid crystal panel at the back of the liquid crystal panel, a frame-like front cover which is made of metal and covers the front of the liquid crystal panel, and a metallic back cover which covers the back of the light guide body. The electronic device is provided with a metallic intermediate member, which is provided to be in contact with the front cover and the back cover and opposed to a side surface of the light guide body, at a position between the front cover and the back cover, and a substrate which is provided to be in tight contact with an inner surface of the intermediate member and on which a plurality of LEDs are mounted.

### CROSS-REFERENCE TO RELATED APPLICATIONS

This application is based upon and claims the benefit of priority from Japanese Patent Application No. 2010-291095, filed Dec. 27, 2010; the entire contents of which are incorporated herein by reference.

### FIELD

Embodiments described herein relate generally to an electronic device which includes a liquid crystal panel.

### BACKGROUND

As regards electronic devices, such as televisions, commercial goods in which LEDs are adopted as backlights (light sources) of liquid crystal panels have become the mainstream in a market. Further, in recent years, various kinds of LEDs are supplied from parts manufacturers, and many high-luminance LEDs for backlight are supplied.

On the other hand, releasing heat stored in a periphery of a light source smoothly to the outside has conventionally been and is still important. Therefore, there is a need for improvement in the heat radiation performance as stated above.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary front view which shows a television, which is an example of an electronic device of a first embodiment;

FIG. 2 is an exemplary exploded perspective view which shows the television shown in FIG. 1;

FIG. 3 is an exemplary sectional view taken along line F3-F3 shown in FIG. 1;

FIG. 4 is an exemplary sectional view which shows a television, which is an example of an electronic device of a second embodiment; and

FIG. 5 is an exemplary sectional view which shows a television, which is an example of an electronic device of a third embodiment.

### DETAILED DESCRIPTION

Various embodiments will be described hereinafter with reference to the accompanying drawings.

In general, according to one embodiment, an electronic device is provided with a liquid crystal panel, a light guide body which is opposed to the liquid crystal panel at the back of the liquid crystal panel, a frame-like front cover which is made of metal and covers the front of the liquid crystal panel, and a metallic back cover which covers the back of the light guide body. The electronic device is provided with a metallic intermediate member, which is provided to be in contact with the front cover and the back cover and opposed to a side surface of the light guide body, at a position between the front cover and the back cover, and a substrate which is provided to be in tight contact with an inner surface of the intermediate member and on which a plurality of LEDs are mounted.

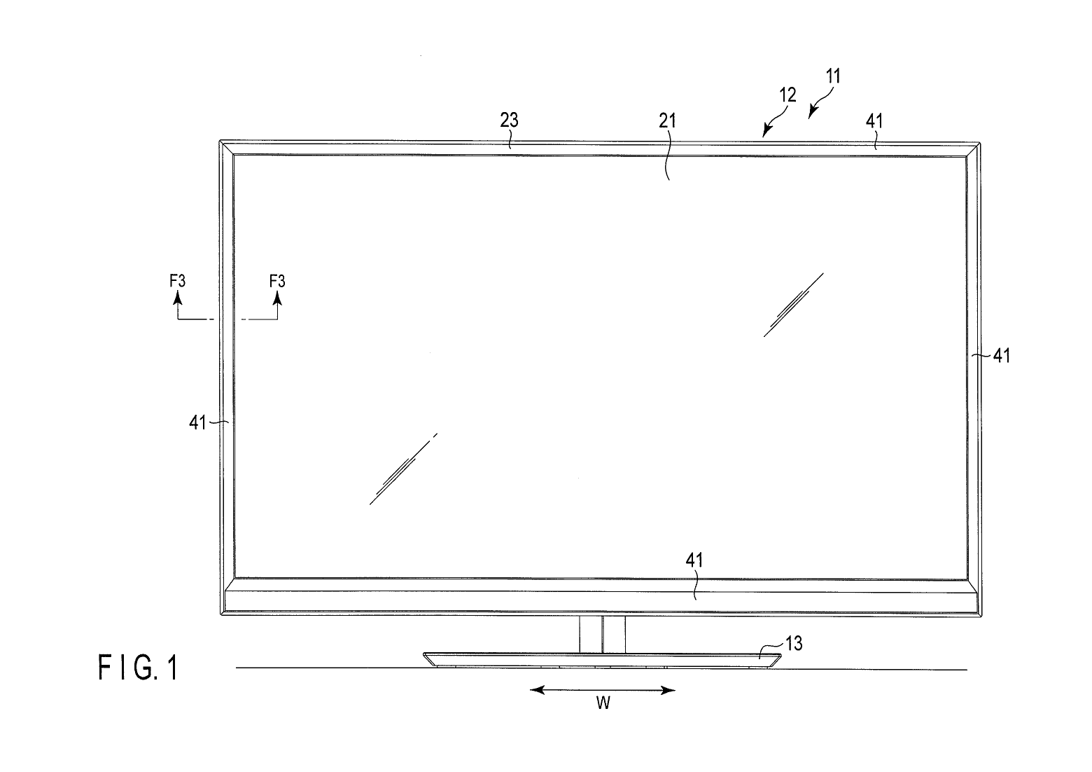

An embodiment of a television, which is an example of an electronic device will now be described with reference to FIGS. 1 to 3. As shown in FIG. 1, a television 11 is a thin-shaped display device having a rectangular form. As shown in FIG. 1, the television 11 comprises a main body 12, and a stand 13 which supports the main body 12.

As shown in FIGS. 1 to 3, the television 11 comprises: a liquid crystal panel 21 having a first surface 21A and a second surface 21B; a plate-like light guide body 22 provided on the back of the liquid crystal panel 21 (the side of the second surface 21B); a frame-like front cover (first cover) 23 which is made of metal and covers the front of the liquid crystal panel 21 (the side of the first surface 21A); a back cover (second cover) 24 which is made of metal and covers the back of the light guide body 22 (the side of the second surface 21B); a metallic intermediate member (middle frame) 25 which is provided at a position between the front cover 23 and the back cover 24; a substrate 26 which is provided to be in tight contact with an inner surface of the intermediate member 25; a first screw 27, which is an example of a fixing member configured to fix the front cover 23, the back cover 24, and the intermediate member 25; a control substrate 28 and an LED driver substrate 29; a square-shaped first shield case 31 which covers the control substrate 28; a square-shaped second shield case 32 which covers the LED driver substrate 29; a first heat insulator 33 which is interposed between the liquid crystal panel 21 and the front cover 23; a second heat insulator 34 which is interposed between the liquid crystal panel 21 and the intermediate member 25; and a third heat insulator 35 which is interposed between the intermediate member 25 and the light guide body 22.

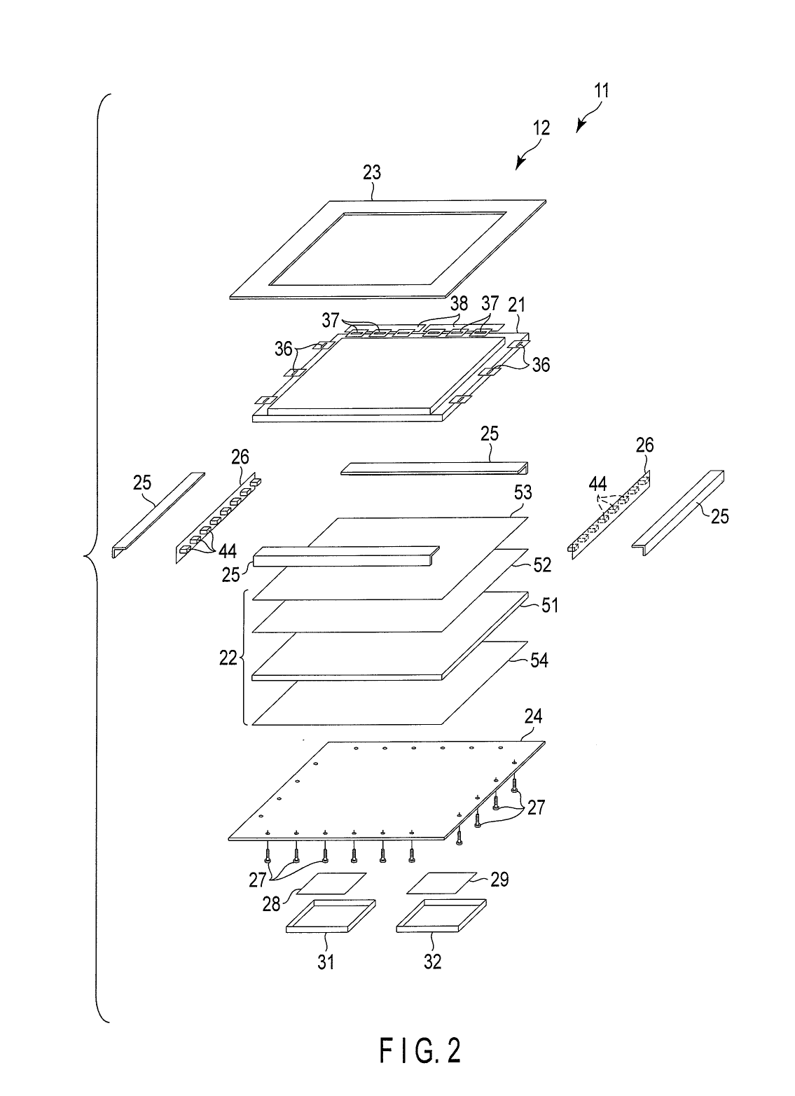

The liquid crystal panel 21 is formed by bonding together two glass plates, for example, and a liquid crystal is filled therein. Further, on each of a front surface and a back surface of the liquid crystal panel 21, a polarizing plate, which is not shown, is adhered. As shown in FIG. 2, the liquid crystal panel 21 includes a gate driver 36, a source driver 37, and a source substrate 38.

The front cover 23 is formed to have a frame-like configuration by a metal material, such as an aluminum base alloy which has good thermal conductivity. As shown in FIG. 1, the front cover 23 is formed by connecting a total of four bar-like members 41, which constitute each side of the front cover 23, to have a frame-like configuration. Each of the bar-like members 41 has a substantially “L-shaped” cross section.

The back cover 24 is formed of a metal material, such as an aluminum base alloy. The intermediate member 25 is formed of a metal material, such as an aluminum base alloy.

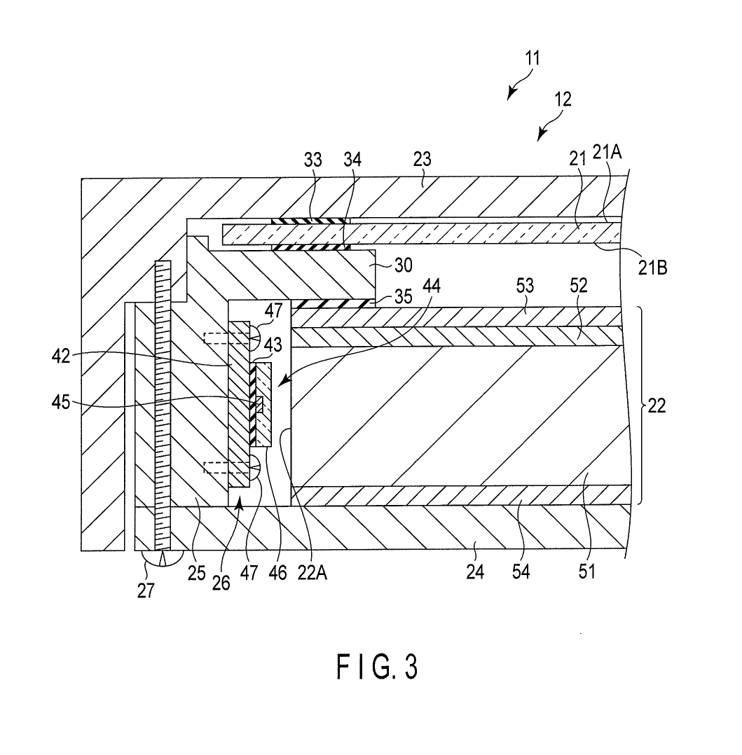

As shown in FIG. 2, the total number of the intermediate members 25 is four, corresponding to each side of the liquid crystal panel 21. Each of the intermediate members 25 is formed like a bar, and has a substantially “L-shaped” cross section. As shown in FIG. 3, each of the intermediate members 25 is opposed to a side surface 22A of the light guide body 22, and is arranged to contact the front cover 23 and the back cover 24. The intermediate member 25 has a projected portion 30 which is projected in a direction substantially parallel to the liquid crystal panel 21 and the light guide body 22. The projected portion 30 is configured to hold the light guide body 22 between the projected portion 30 and the back cover 24, and to hold the liquid crystal panel 21 between the projected portion 30 and the front cover 23.

The substrate 26 is provided to be opposed to the side surface 22A of the light guide body 22. The substrate 26 comprises a plate-like base 42 which is made of an aluminum base alloy, for example, a wiring portion 43 which is provided on one surface of the base 42 and in which an insulating layer and a copper foil layer are stacked alternately, and an LED 44 for backlight which is provided on a surface of the wiring portion 43. The LED 44 for backlight includes a semiconductor element 45, and a sealing member 46 which is provided on a surface of the semiconductor element 45 and contains a fluorescence substance. A plurality of LEDs 44 for backlight (only one of which was described for simplicity) are arranged on the surface of the wiring portion 43 laterally. The base 42 is fixed to an inner surface of the intermediate member 25 by a second screw 47.

The first heat insulator 33 is formed of a rubber sheet, for example, and also serves as a cushioning material which prevents the liquid crystal panel 21 and the front cover 23 from colliding with each other. Further, the second heat insulator 34 is formed of a rubber sheet, for example, and serves as a cushioning material which prevents the liquid crystal panel 21 and the projected portion 30 of the intermediate member 25 from colliding with each other. The third heat insulator 35 is formed of a rubber sheet, for example, and serves as a cushioning material which prevents the projected portion 30 of the intermediate member 25 and the light guide body 22 from colliding with each other.

The light guide body 22 is arranged to face the liquid crystal panel 21. The light guide body 22 has, for example, a light guide plate 51 having the form of a plate, a prism sheet 52 which is provided in front of the light guide plate 51, a polarizing sheet 53 which is provided in front of the prism sheet 52, and a reflection sheet 54 which is provided at the back of the light guide plate 51. The light guide body 22 is structured by overlapping the light guide plate 51, the prism sheet 52, the polarizing sheet 53, and the reflection sheet 54. In the present embodiment, the light guide body 22 is structured by a total of four sheets. However, other kinds of sheet may further be included or the number of sheets may be reduced.

As shown in FIG. 3, light which is irradiated from the LED 44 is irradiated into the light guide plate 51, passes through the prism sheet 52 and the polarizing sheet 53, and can illuminate the liquid crystal panel 21 from the back. Further, of the light which has been irradiated into the light guide plate 51, the light which is irradiated toward the back is reflected by the reflection sheet 54, passes through the prism sheet 52 and the polarizing sheet 53, and can illuminate the liquid crystal panel 21 from the back. By doing so, an image is displayed on the liquid crystal panel 21.

In the present embodiment, in assembling the television 11, first of all, the front cover 23 is structured like a frame. Next, the liquid crystal panel 21 is fitted with the front cover 23. The intermediate member 25 is arranged to be overlapped with the liquid crystal panel 21. On an inner surface of the intermediate member 25, the substrate 26 on which the LEDs 44 for backlight are mounted is fixed in advance by a first screw 27. Further, the light guide body 22 is arranged to be overlapped with the projected portion 30 of the intermediate member 25. Lastly, the back cover 24 is arranged to be overlapped with the light guide body 22, and the front cover 23, the back cover 24, and the intermediate member 25 are fixed by the first screw 27. By fixing the control substrate 28, the LED driver substrate 29, the first shield case 31, and the second shield case 32 on the back cover 24, assembly of the main body 12 is completed. Further, the stand 13 is attached to the main body 12 to accomplish the television 11.

According to the first embodiment, the television 11 comprises: the liquid crystal panel 21; the light guide body 22 which is opposed to the liquid crystal panel 21 at the back of the liquid crystal panel 21; the frame-like front cover 23 which is metallic and covers the front of the liquid crystal panel 21; the metallic back cover 24 which covers the back of the light guide body 22; the metallic intermediate member 25, which is provided to be in contact with the front cover 23 and the back cover 24 and opposed to the side surface 22A of the light guide body 22, at a position between the front cover 23 and the back cover 24; and the substrate 26 which is provided to be in tight contact with the inner surface of the intermediate member 25, and on which a plurality of LEDs are mounted.

Generally, when heat of the LED 44 for backlight is accumulated inside a cover, the heat is conveyed to the liquid crystal panel 21 and the liquid crystal panel 21 may be adversely affected. More specifically, if the heat is applied to the liquid crystal panel 21, motion (reactivity) of a liquid crystal provided inside will be improved, which causes non-uniformity in an image of a portion to which the heat is applied of the liquid crystal panel 21. Further, thermal expansion may occur in a polarizing plate which is bonded to each of a front surface and a back surface of the liquid crystal panel 21. As a result, there is a fear that the polarizing plate does not perform a desired function.

The structure stated above enables heat generated from the LED 44 to be dissipated to the metallic intermediate member 25. Further, since the intermediate member 25 is brought into contact with the metallic front cover 23 and the metallic back cover 24, the heat conveyed to the intermediate member 25 from the LED 44 can be conveyed to the front cover 23 and the back cover 24 as well. Because of this, the heat generated from the LED 44 can be dissipated in the front cover 23, the back cover 24, and the intermediate member 25, and also be emitted outside from the front cover 23, the back cover 24, and the intermediate member 25. Therefore, it is possible to prevent the heat of the LED 44 from being accumulated inside and adversely affecting the liquid crystal panel 21 and the like as much as possible.

The television 11 comprises the first heat insulator 33 which is interposed between the liquid crystal panel 21 and the front cover 23, and the second heat insulator 34 which is interposed between the liquid crystal panel 21 and the intermediate member 25. With this structure, it is possible to prevent the heat from the LED 44 from being conveyed to the liquid crystal panel 21 via the front cover 23 and the intermediate member 25 as much as possible.

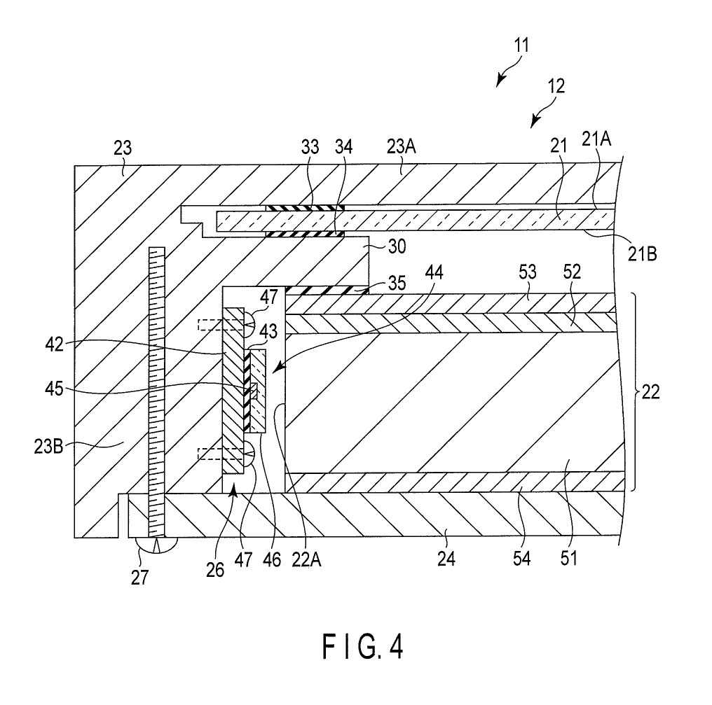

Next, a second embodiment of a television, which is an example of an electronic device, will be described with reference to FIG. 4. A television 11 of the second embodiment is different from that of the first embodiment in that the front cover 23 and the intermediate member 25 as described above in the first embodiment are integrally formed as one piece, namely, that the intermediate member 25 is omitted. However, the other parts are in common with those of the first embodiment. Accordingly, an explanation will be given mainly for the different parts, and an explanation will be omitted for the common parts by assigning the same reference numerals thereto. The television 11 has the same appearance as the television 11 of the first embodiment shown in FIG. 1.

A front cover (first cover) 23 includes a frame-like front part 23A which covers the front of a liquid crystal panel 21, and a side part 23B which is opposed to a side surface 22A of a light guide body 22. The front cover 23 is formed of a metal material, such as an aluminum base alloy which has good thermal conductivity. The side part 23B contacts a back cover 24. The side part 23B has a projected portion 30 which is projected in a direction substantially parallel to the liquid crystal panel 21 and the light guide body 22. The projected portion 30 can hold the light guide body 22 between the projected portion 30 and the back cover 24, and also hold the liquid crystal panel 21 between the projected portion 30 and the front part 23A.

The front cover 23 is formed by connecting a total of four bar-like members 41, which constitute each side of the front cover 23, to have a frame-like configuration.

A substrate 26 is provided to be in tight contact with an inner surface of the side part 23B. The substrate 26 is opposed to the side surface 22A of the light guide body 22. The substrate 26 is fixed to the side part 23B by a second screw 47. The structure of the substrate 26 is the same as that of the first embodiment.

A first heat insulator 33 is interposed between the liquid crystal panel 21 and the front part of the front cover 23. A second heat insulator 34 is interposed between the liquid crystal panel 21 and the projected portion 30 of the side part 23B. A third heat insulator 35 is interposed between the projected portion 30 of the side part 23B and the light guide body 22.

In the present embodiment, in structuring the front cover 23 as a frame, the liquid crystal panel 21 is fitted inside the frame. In a state where the front cover 23 is structured as a frame, the liquid crystal panel 21 is held in a position between the front part 23A and the projected portion 30. By arranging the light guide body 22 and the back cover 24 with respect to the front cover 23, assembly of a main body 12 of the television 11 is completed. Further, a stand 13 is attached to the main body 12 to accomplish the television 11.

According to the second embodiment, the television 11 comprises the liquid crystal panel 21, the light guide body 22, which is opposed to the liquid crystal panel 21 at the back of the liquid crystal panel 21, the metallic back cover 24 covering the back of the light guide body 22, the metallic front cover 23 including the frame-like front part 23A which covers the front of the liquid crystal panel 21 and the side part 23B which contacts the back cover 24 and is opposed to the side surface 22A of the light guide body 22, and the substrate 26 which is provided to be in tight contact with an inner surface of the side part 23B and on which a plurality of LEDs 44 are mounted.

The above structure enables heat generated from the LEDs 44 to be dissipated to the side part 23B of the metallic front cover 23. Further, since the side part 23B is brought into contact with the metallic back cover 24, the heat conveyed to the side part 23B from the LEDs can be conveyed to the back cover 24 and the front part 23A of the front cover 23. Because of this, the heat generated from the LEDs 44 can be dissipated in the front cover 23 and the back cover 24, and also be emitted outside from the front cover 23 and the back cover 24. Therefore, it is possible to prevent the heat of the LEDs 44 from being accumulated inside and adversely affecting the liquid crystal panel 21 and the like as much as possible.

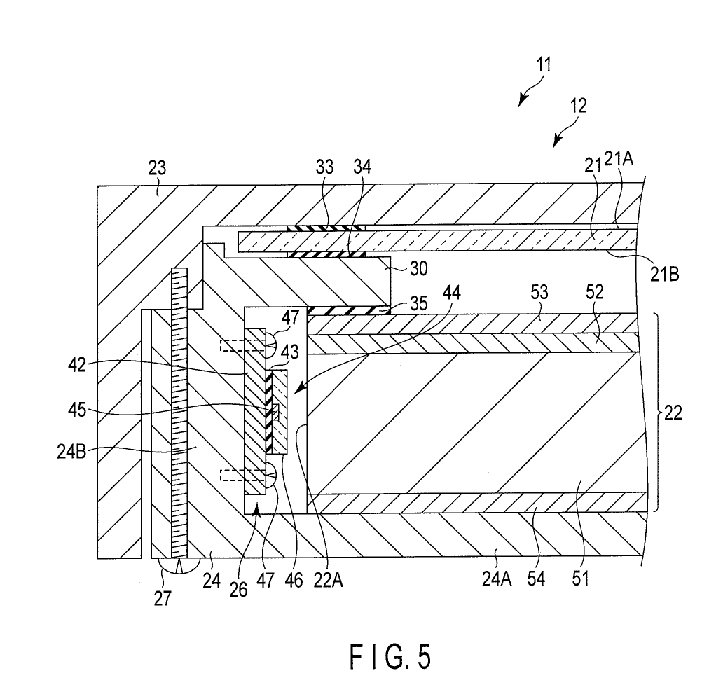

A third embodiment of a television, which is an example of an electronic device, will now be described with reference to FIG. 5. A television 11 of the third embodiment is different from that of the first embodiment in that the back cover 24 and the intermediate member 25 as described above in the first embodiment are integrally formed as one piece, namely, that the intermediate member 25 is omitted. However, the other parts are in common with those of the first embodiment. Accordingly, an explanation will be given mainly for the different parts, and an explanation will be omitted for the common parts by assigning the same reference numerals thereto. The television 11 has the same appearance as the television 11 of the first embodiment shown in FIG. 1.

A back cover (second cover) 24 includes a plate-like rear portion (cover portion) 24 which covers the back of a liquid crystal panel 21 (second surface side 21B), and a side part 24B which is opposed to a side surface 22A of a light guide body 22. The back cover 24 is formed of a metal material, such as an aluminum base alloy which has good thermal conductivity. The side part 24B contacts a front cover (first cover) 23. The side part 24B has a projected portion 30 which is projected in a direction substantially parallel to the liquid crystal panel 21 and the light guide body 22. The projected portion 30 can hold the light guide body 22 between the projected portion 30 and the rear portion (cover portion) 24A, and also hold the liquid crystal panel 21 between the projected portion 30 and the front cover 23.

A substrate 26 is provided to be in tight contact with an inner surface of the side part 24B. The substrate 26 is opposed to the side surface 22A of the light guide body 22. The substrate 26 is fixed to the side part 24B by a second screw 47. The structure of the substrate 26 is the same as that of the first embodiment.

A first heat insulator 33 is interposed between the liquid crystal panel 21 and the front cover 23. A second heat insulator 34 is interposed between the liquid crystal panel 21 and the projected portion 30 of the side part 24B. A third heat insulator 35 is interposed between the projected portion 30 of the side part 24B and the light guide body 22.

In the present embodiment, the back cover 24 is divided into two parts as a first section and a second section at an intermediate portion in the width direction W, for example. In assembling the back cover 24, in a state where the light guide body 22 is fitted at a position between the projected portion 30 of the side part 24B and the rear portion 24A in advance, the first section and the second section are fixed to each other by a screw, for example, to structure an integral back cover 24. After that, the liquid crystal panel 21 is mounted on the integral back cover 24, and the front cover 23 is arranged on top of the liquid crystal panel 21. By fixing the back cover 24 and the front cover 23 with a first screw 27, a main body 12 of the television 11 is completed. Further, a stand 13 is attached to the main body 12 to accomplish the television 11.

According to the third embodiment, the television 11 comprises the liquid crystal panel 21, the light guide body 22, which is opposed to the liquid crystal panel 21 at the back of the liquid crystal panel 21, the metallic front cover 23 having a frame-like structure which covers the front of the liquid crystal panel 21, the metallic back cover 24 which includes the rear portion 24A covering the back of the light guide body 22 and the side part 24B which contacts the front cover 23 and is opposed to the side surface 22A of the light guide body 22, and the substrate 26 which is provided to be in tight contact with an inner surface of the side part 24B and on which a plurality of LEDs 44 are mounted.

The above structure enables heat generated from the LEDs 44 to be dissipated to the side part 24B of the metallic back cover 24. Further, since the side part 24B is brought into contact with the metallic front cover 23, the heat conveyed to the side part 24B from the LEDs 44 can be conveyed to the front cover 23 and the rear portion 24A. Because of this, the heat generated from the LEDs 44 can be dissipated in the front cover 23 and the back cover 24, and also be emitted outside from the front cover 23 and the back cover 24. Therefore, it is possible to prevent the heat of the LEDs 44 from being accumulated inside and adversely affecting the liquid crystal panel 21 and the like as much as possible.

The electronic device described in the present specification is not limited to the television 11 indicated in the above-mentioned embodiments, and may be embodied as other types of electronic devices, such as a portable computer, a cellular phone, and an e-book reader which electronically displays documents and images, etc.

The electronic device is not limited to the above embodiments, and may be embodied by modifying constituent features without departing from the spirit when the electronic device is put into practice. Further, various inventions can be achieved by suitably combining the constituent features disclosed in the above embodiments. For example, some constituent features may be deleted from the entire constituent features shown in the embodiments. Further, constituent features of different embodiments may be combined suitably.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a liquid crystal panel;
a light guide opposite the liquid crystal panel;
a metallic frame-like front cover over the liquid crystal panel;
a metallic back cover over the light guide;
a metallic intermediate member configured to contact the front cover and the back cover and is opposite a side surface of the light guide between the front cover and the back cover; and
a substrate configured to contact an inner surface of the intermediate member and on which a plurality of LEDs are mounted.

2. The electronic device of claim 1, further comprising:
a first heat insulator interposed between the liquid crystal panel and the front cover; and
a second heat insulator interposed between the liquid crystal panel and the intermediate member.

3. An electronic device comprising:
a liquid crystal panel;
a light guide opposite the liquid crystal panel;
a metallic back cover over the light guide;
a metallic frame-like front cover over the liquid crystal panel, and a side part configured to contact the back cover opposite a side surface of the light guide; and
a substrate configured to contact an inner surface of the side part and on which a plurality of LEDs are mounted.

4. The electronic device of claim 3, further comprising:
a first heat insulator interposed between the liquid crystal panel and the front part; and
a second heat insulator interposed between the liquid crystal panel and the side part.

5. An electronic device comprising:
a liquid crystal panel including a first surface and a second surface on an opposite side of the first surface;
a light guide opposite the liquid crystal panel along the second surface side of the liquid crystal panel;
a metallic frame-like first cover over the first surface side of the liquid crystal panel;
a metallic second cover over the light guide on the second surface side of the liquid crystal panel, and a side part configured to contact the first cover opposite a side surface of the light guide; and
a substrate configured to contact an inner surface of the side part and on which a plurality of LEDs are mounted.

6. The electronic device of claim 5, further comprising:
a first heat insulator interposed between the liquid crystal panel and the first cover; and
a second heat insulator interposed between the liquid crystal panel and the side part.
